(19) United States
(12) Patent Application Publication
(10) Pub. No.: US 2016/0090726 A1
(43) Pub. Date: Mar. 31, 2016

(54) Coupling Assembly for Closet Carrier System

(71) Applicant: Zurn Industries, LLC, Milwaukee, WI (US)

(72) Inventors: William A. Verdecchia, Erie, PA (US); Jason E. Morris, Erie, PA (US); Vitaliy Lisichenko, Erie, PA (US); Robert DiPlacido, Erie, PA (US)

(21) Appl. No.: 14/695,102

(22) Filed: Apr. 24, 2015

Related U.S. Application Data
(60) Provisional application No. 62/055,696, filed on Sep. 26, 2014.

(51) Int. Cl. E03D 11/16; F16L 41/08; F16L 15/08; E03D 11/13; F16L 27/00

(52) U.S. Cl. CPC E03D 11/16; E03D 11/135; F16L 27/00; F16L 15/08; F16L 41/08

(57) ABSTRACT

A coupling assembly for a closet carrier system for a water closet includes a central pipe member having a first end and a second end, and an interior surface defining a hollow interior; an adapter member separate from the central pipe member and connected to the second end of the central pipe member, the adapter having an interior surface defining a hollow interior and configured to adjustably connect the coupling assembly to a faceplate of the system; and a horn coupling member configured to be connected to the first end of the central pipe member. At least the hollow interior of the central pipe member and the hollow interior of the adapter member form an internal passage of the coupling assembly. The horn coupling member is configured to be connected to a water closet to place the internal passage of the coupling assembly in fluid communication with the water closet.

### CROSS REFERENCE TO RELATED APPLICATION

The present application claims priority from U.S. Provisional Patent Application No. 62/055,696, filed on Sep. 26, 2014, which is incorporated herein by reference in its entirety.

### BACKGROUND OF THE INVENTION

1. Field of the Invention

The invention relates to a coupling for placing a wall-mounted water closet in communication with a carrier assembly and waste fitting, and, in particular, to a multi-piece coupling assembly.

2. Description of Related Art

Typical closet carrier systems and fittings are designed for mounting and supporting water closets on a wall surface and for placing such water closets in fluid communication with a waste fitting and a building waste disposal system. Such typical systems utilize a one-piece adjustable coupling that extends from a faceplate of the carrier system in an adjustable manner and couples a rear of the water closet to the carrier system and the waste fitting in order to place the water closet in fluid communication with the carrier system and the waste fitting.

Typical one-piece adjustable couplings suffer from some deficiencies. For instance, because the coupling is a single piece intended to connect to the rear of a water closet at one end and to the faceplate of a carrier assembly at the other end, the overall length of the coupling cannot be adjusted to accommodate variations in the spacing of the faceplate from the water closet due to the construction of the wall or the available space. Also, if a portion of the adjustable coupling were to be damaged or wear prematurely, the entire coupling must be disassembled from the carrier assembly and replaced, which can require a large amount of time and labor to effect the repairs. Finally, if a water closet is to be replaced, the entire adjustable coupling may require replacement if the adjustable coupling is not properly configured to connect to the rear of the replacement water closet.

### SUMMARY OF THE INVENTION

Accordingly, there is a general need in the art for a multi-piece adjustable coupling assembly that couples a wall-mounted water closet to a carrier assembly and waste fitting, and that may be adjusted in size, may be configured to connect to a variety of water closets, and includes replaceable components.

According to an embodiment of the present invention, a three-piece coupling assembly is utilized in a closet carrier system. The coupling assembly connects the rear of a wall-mounted water closet to a carrier faceplate and fitting member of the closet carrier system. The coupling assembly includes a horn coupling member, which has an enlarged diameter at one end for connecting the coupling assembly to the rear of the water closet, a central pipe member, and a threaded adapter member, which includes external threading at one end for threadably coupling the coupling assembly to the faceplate of the carrier system. The horn coupling member is disposed on the central pipe member on a first end of the central pipe member and is secured to the central pipe member by an adhesive, such as PVC cement. The first end of the central pipe member is aligned with a base of the enlarged diameter portion of the horn coupling member. The threaded adapter member is disposed on the central pipe member on an opposing second end of the central pipe member and is secured to the central pipe member by an adhesive, such as PVC cement. The threaded adapter member includes an internal flange that abuts the second end of the central pipe member and an external flange that abuts the faceplate to create a positive sealing engagement between the coupling assembly and the faceplate. A length of the central pipe member may be adjusted by cutting the length of the member. The coupling assembly may also include a cap member that is disposed on the first end of the central pipe member prior to attachment of the horn coupling member to the central pipe member. The cap member sealingly engages and closes off the first end of the central pipe member to allow for pressure testing of the system prior to connection to the water closet. The cap may be connected to the first end of the central pipe member by an adhesive, such as PVC cement. The cap can be removed from the central pipe member after pressure testing is completed and replaced with the horn coupling member to connect the coupling assembly and the carrier system to the rear of the water closet. Alternatively, the central pipe member may include a diaphragm that is sealingly disposed in or integrally molded within the central pipe member to allow for pressure testing of the system. The diaphragm can be knocked out of or otherwise removed from the coupling tube after the pressure test is complete. During installation, the connection between the coupling assembly, the faceplate, and the fitting is pressure tested to determine that the system is sealed, then the length of the central pipe member may be adjusted by cutting the length of the tube. If the cap and/or the diaphragm is not removed by cutting, it can be knocked off or out of the central pipe member, the horn coupling member can then be glued to the first end of the central pipe member, and the adjustable coupling assembly re-connected to the faceplate.

According to a particular embodiment of the present invention, a coupling assembly for a closet carrier system for a water closet is provided. The coupling assembly includes a central pipe member having a first end and a second end, and an interior surface defining a hollow interior; an adapter member separate from the central pipe member and connected to the second end of the central pipe member, the adapter having an interior surface defining a hollow interior and the adapter member being configured to adjustably connect the coupling assembly to a faceplate of the closet carrier system; and a horn coupling member configured to be connected to the first end of the central pipe member. At least the hollow interior of the central pipe member and the hollow interior of the adapter member form an internal passage of the coupling assembly. The horn coupling member is configured to be connected to a water closet to place the internal passage of the coupling assembly in fluid communication with the water closet.

According to another particular embodiment of the present invention, a closet carrier system for a water closet is provided. The closet carrier system includes a faceplate; at least one vertical support adjustably connected to the faceplate for supporting the system on a floor surface; and a coupling assembly connected to and extending from the faceplate. The coupling assembly includes a central pipe member having a first end and a second end, and an interior surface defining a hollow interior; an adapter member separate from the central pipe member and connected to the second end of the central pipe member, the adapter having an interior surface defining a hollow interior and the adapter member adjustably connecting the coupling assembly to the faceplate; and a horn coupling member configured to be connected to the first end of the central pipe member. At least the hollow interior of the central pipe member and the hollow interior of the adapter member form an internal passage of the coupling assembly. The horn coupling member is configured to be connected to a water closet to place the internal passage of the coupling assembly in fluid communication with the water closet.

According to another particular embodiment of the present invention, a method of assembling a closet carrier system for a water closet is provided. The method includes providing a faceplate; providing at least one vertical support; adjustably connecting the at least one vertical support to the faceplate for supporting the carrier system on a floor surface; and providing a coupling assembly. The coupling assembly includes a central pipe member having a first end and a second end, and an interior surface defining a hollow interior; an adapter member separate from the central pipe member, the adapter having an interior surface defining a hollow interior; and a horn coupling member. The method further includes fixedly connecting the adapter member to the second end of the central pipe member such that the hollow interior of the central pipe member and the hollow interior of the adapter member form at least a portion of an internal passage of the coupling assembly; fixedly connecting the horn coupling member to the first end of the central pipe member; and adjustably connecting the adapter member to the faceplate to connect the coupling assembly to the faceplate. The horn coupling member is configured to be connected to a water closet to place the internal passage of the coupling assembly in fluid communication with the water closet.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 depicts an upper front perspective view of a closet carrier system having a coupling assembly in accordance with an embodiment of the present invention;

FIG. 2 depicts a perspective view of the coupling assembly in accordance with an embodiment of the present invention in a pre-use configuration;

FIG. 3 depicts a side view of the coupling assembly of FIG. 2 in the pre-use configuration;

FIG. 4 depicts a cross-sectional side view of the coupling assembly of FIG. 2 in the pre-use configuration taken along lines 4-4 shown in FIG. 3;

FIG. 5 depicts a perspective view of the coupling assembly of FIG. 2 in a use configuration; and

FIG. 6 depicts a cross-sectional side view of the coupling assembly of FIG. 2 in the use configuration.

### DETAILED DESCRIPTION OF THE INVENTION

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

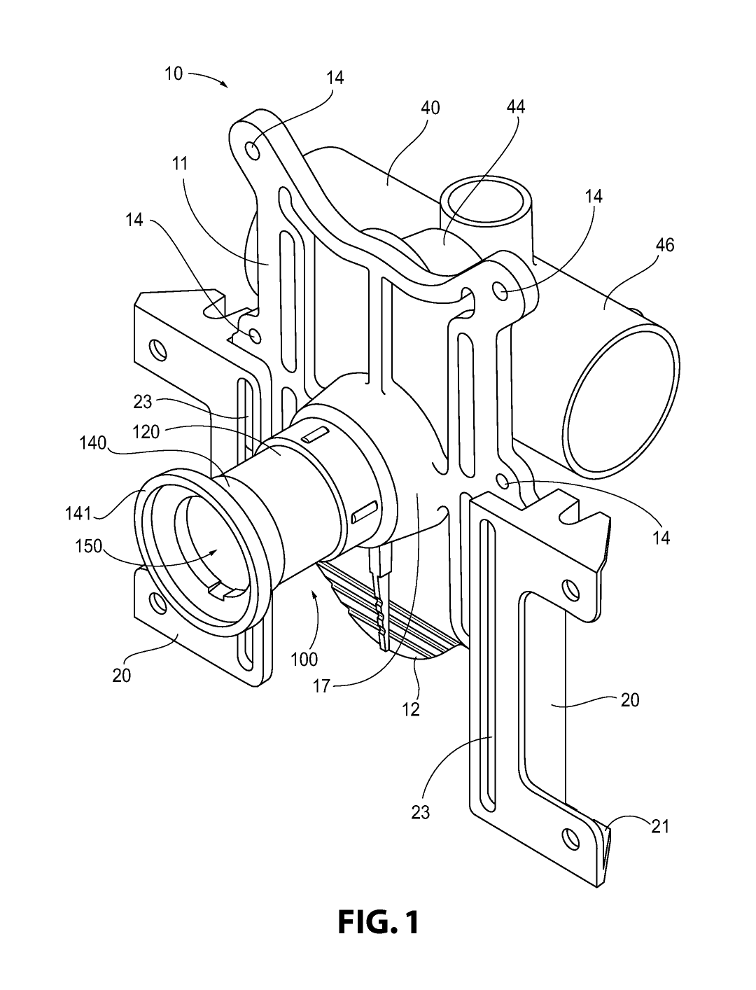

With reference to FIG. 1, a closet carrier system 10 is shown in accordance with an embodiment of the present invention. The closet carrier system 10 includes a faceplate 11 having a first side 12 facing upstream with respect to the flow of waste fluid through the system 10 and a second side facing downstream. The faceplate 11 includes an internally-threaded horn 17 extending from the first side 12 of the faceplate 11. The horn 17 is provided for connecting an adjustable coupling assembly 100, which will be discussed in further detail below, to the faceplate 11, such that the coupling assembly 100 extends from the first side 12 of the faceplate 11. The horn 17 surrounds an opening extending through the faceplate 11 from the first side 12 to the second side. The horn 17 may include a notch (not shown) defined therein that receives an O-ring (not shown) to seal the engagement between the coupling assembly 100 and the horn 17.

The faceplate 11 includes at least two threaded holes 14 that are provided for connecting a support arrangement, such as horizontally-extending threaded rods or carriage bolts (not shown), to the faceplate 11. The support arrangement serves to structurally connect the water closet to the faceplate 11 such that the closet carrier system 10 is able to support the weight of the water closet and the user on the structure.

The closet carrier system 10 also includes at least one vertical support 20 for supporting the system 10 on a floor surface. Preferably, the system 10 includes at least two vertical supports 20 provided on each of the lateral sides of the faceplate 11, as shown in FIG. 1. Each vertical support 20 includes a foot 21 configured to engage the floor of the structure, wherein the water closet is mounted such that the at least two vertical supports 20 support the weight of the water closet on the floor of the structure. Each of the at least two vertical supports 20 also includes a vertical elongated slot 23, which is provided for receiving fasteners (not shown) to connect the vertical support 20 to the first side 12 of the faceplate 11. The fasteners extend through the elongated slot 23 and engage holes (not shown) defined in the faceplate 11 in order to adjustably connect the faceplate 11 to the vertical support 20. In this manner, the vertical position of the faceplate 11 with respect to the floor of the structure may be adjusted during installation of the system 10. According to one embodiment, each of the vertical supports 20 may be symmetric in shape with a foot 21 provided at each end of the vertical supports 20 such that the vertical support 20 is reversible and may be connected to either one of the right and left sides of the faceplate 11.

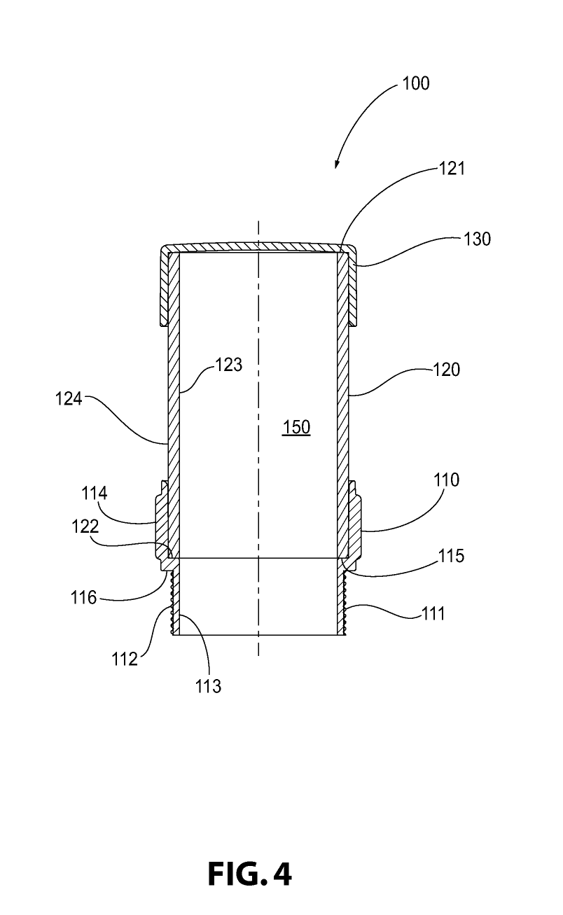

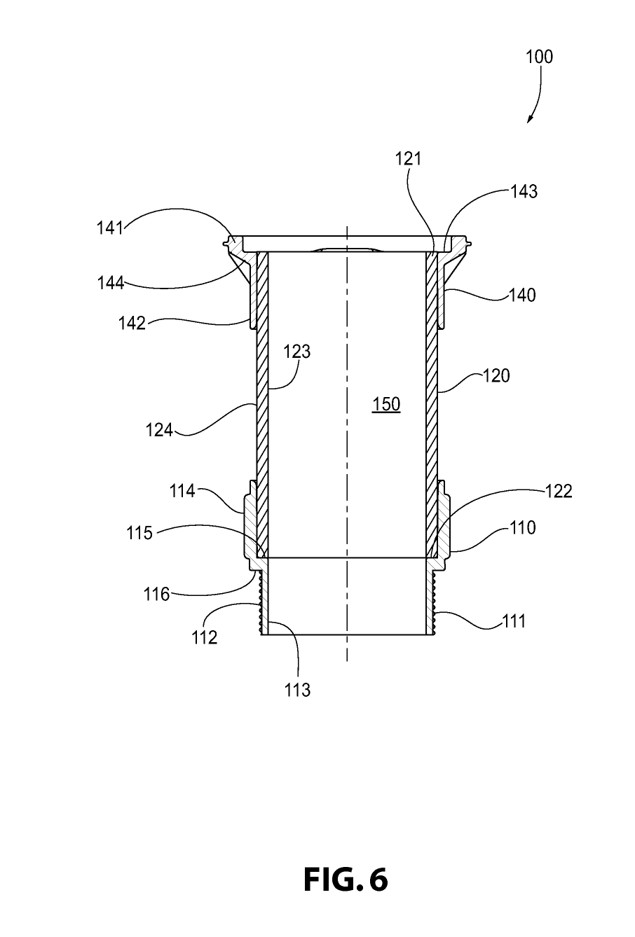

The carrier system 10 further includes a waste fitting 40 connected to the second side of the faceplate 11. The waste fitting 40 includes an endplate, an inlet defined within the endplate, an intermediate portion, and a main body 46 defining a main passageway of the fitting 40. The waste fitting 40 is connected to the second side of the faceplate 11 by way of the endplate that receives fasteners (not shown) that connect the endplate to the faceplate 11. The endplate of the fitting 40 is connected to the second side of the faceplate 11, such that the inlet is in fluid communication with an internal passage 150 (shown in FIGS. 4 and 6) of the adjustable coupling assembly 100. The coupling assembly 100 may be connected to the horn 17 of the faceplate 11 so as to extend through the faceplate 11 and be in direct fluid communication with the inlet of the fitting 40. A gasket (not shown) may be provided between the endplate and the second side of the faceplate 11 in a position surrounding the inlet to seal the engagement between the faceplate 11 and the endplate of the fitting 40. The waste fitting 40 also includes an oblong circular plenum chamber or bubble 44 at the upstream end thereof on which the endplate is disposed. The main passageway of the fitting 40 is configured to be connected with the fluid waste system of the building so as to convey fluid waste from the fitting 40 to the fluid waste system. Accordingly, waste fluid flushed from the water closet is conveyed from the water closet through the internal passage of the coupling assembly 100 and into the waste fitting 40 via the inlet. The waste fluid then passes into the main passageway defined in the main body 46 of the fitting 40 where it is then conveyed into the building's fluid waste system in a manner well known to those having ordinary skill in the art.

Aside from the coupling assembly 100, the carrier system 10 described above with reference to FIG. 1 is of the type disclosed in Applicant's co-pending U.S. application Ser. No. 14/258,292 filed on Apr. 22, 2014 (published as US 2014/0310860 on Oct. 23, 2014), which is hereby incorporated by reference as if set forth in its entirety herein. However, it is to be appreciated that the carrier system 10 may be of any type known to those having ordinary skill in the art to be suitable for supporting a wall mounted toilet and compatible for use with an adjustable coupling.

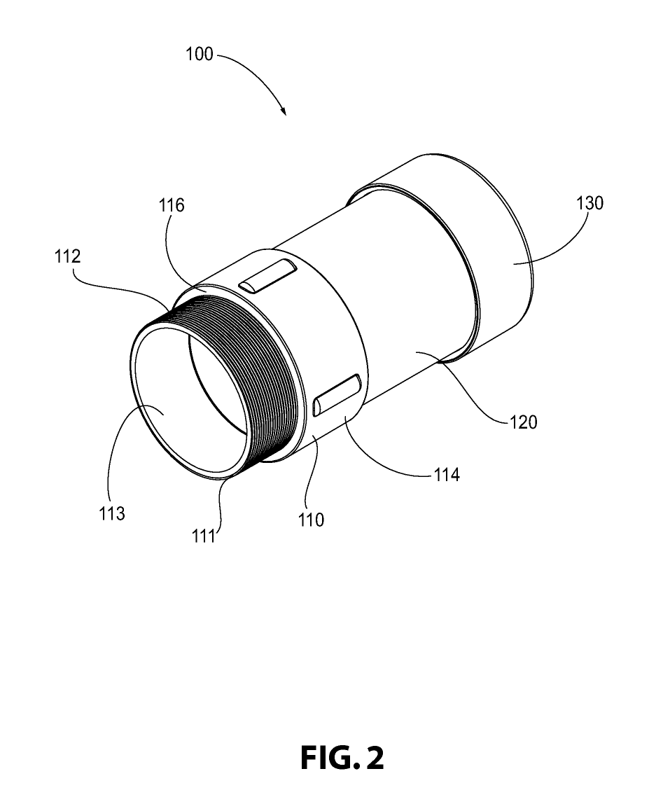

With reference to FIGS. 2-6, the coupling assembly 100 is shown in detail in accordance with an embodiment of the present invention. The coupling assembly 100 includes a central pipe member 120, an adapter member 110 separate from the central pipe member 120, a horn coupling member 140, and may further include a cap member 130. The central pipe member 120 extends between a first end 121 and a second end 122, and has an exterior surface 124 and an interior surface 123 that defines a hollow interior. The adapter member 110 is connected to the second end 122 of the central pipe member 120 and has a threaded portion 111 with external threading 112 on its external surface such that the adapter member 110 is configured to adjustably connect the coupling assembly 100 to the horn 17 of the faceplate 11 discussed above with reference to FIG. 1. The adapter member 110 has an interior surface 113 that defines a hollow interior. At least the hollow interior of the central pipe member 120 and the hollow interior of the adapter member 110 form an internal passage 150 of the coupling assembly 100 when the central pipe member 120 and the adapter member 110 are fastened together. The horn coupling member 140 is configured to be connected to the first end 121 of the central pipe member 120. The horn coupling member 140 is also configured to be connected to a water closet (not shown) to place the internal passage 150 of the coupling assembly 100 in fluid communication with the water closet.

According to one embodiment of the invention, the central pipe member 120 is configured such that its length can be adjusted to accommodate the space provided for installation of the carrier system 10. In particular, the central pipe member 120 is configured such that it can be shortened by cutting away a portion of the central pipe member 120 prior to completion of the assembly of the carrier system 10.

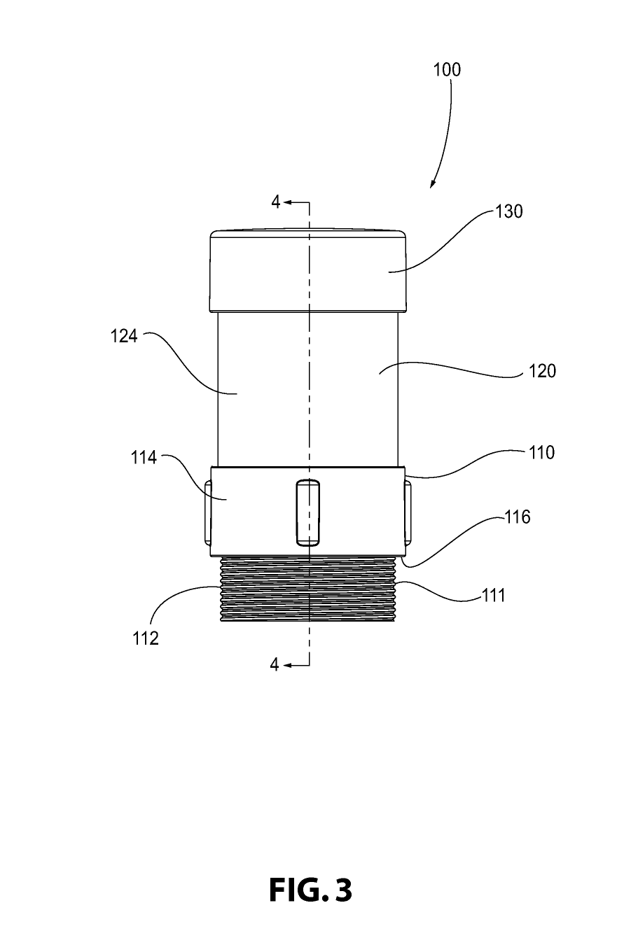

As shown in FIGS. 3 and 4, the coupling assembly 100 may also include the cap member 130, which is configured to be removably connected to the first end 121 of the central pipe member 120. During assembly and installation of the closet carrier system 10 utilizing the coupling assembly 100, the cap member 130 may be placed on the first end 121 of the central pipe member 120 to close the internal passage 150 of the coupling assembly 100 during a pressure test of the carrier system 10. In particular, the cap member 130 includes a hollow body that is fitted over the first end 121 of the central pipe member 120 prior to assembly of the horn coupling member 140 on to the central pipe member 120. The cap member 130 is secured to the central pipe member 120 by an adhesive in order to close and seal the internal passage 150 of the coupling assembly 100. After the carrier system 10 is assembled, including the coupling assembly 100, the system 10 may be pressure tested to ensure that there are no leaks within the system 10 prior to connecting the system 10 to a water closet. The cap member 130 may then be removed from the first end 121 of the central pipe member 120 to allow the horn coupling member 140 to be connected to the central pipe member 120 and to the water closet. The cap member 130 may be removed from the central pipe member 120 either by knocking the cap member 130 off of the central pipe member 120 or by cutting away the portion of the central pipe member 120 to which the cap member 130 is fastened.

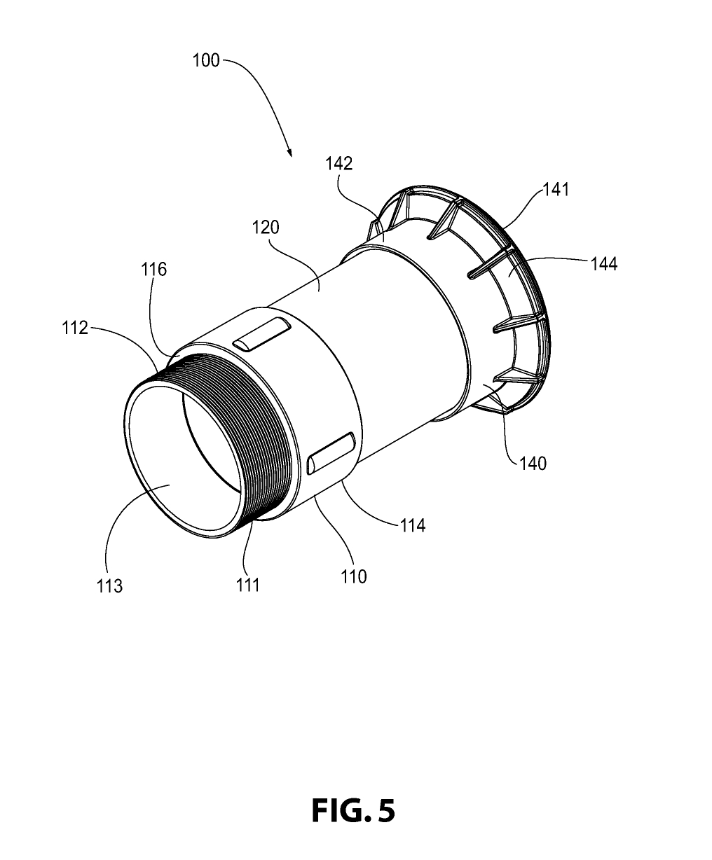

As shown in FIGS. 5 and 6, the adapter member 110 includes a widened portion 114 that receives the second end 122 of the central pipe member 120 such that the interior surface 113 of the adapter member 110 in the widened portion 114 abuts against the exterior surface 124 of the central pipe member 120 at the second end 122 so that the adapter member 110 may be fastened to the central pipe member 120. An internal flange 115 is formed in the interior surface 113 of the adapter member 110 between the threaded portion 111 and the widened portion 114. The internal flange 115 is configured such that the second end 122 of the central pipe member 120 abuts against the internal flange 115 when the central pipe member 120 is fully inserted into the widened portion 114 in order to form a positive engagement between the adapter member 110 and the central pipe member 120. The adapter member 110 also includes an external flange 116 formed in the exterior of the adapter member 110 between the threaded portion 111 and the widened portion 114. The external flange 116 of the adapter member 110 is configured to abut against the horn 17 of the faceplate 11 when the adapter member 110 is fully engaged with the faceplate 11 to form a positive sealing engagement between the coupling assembly 100 and the faceplate 11.

As further shown in FIGS. 5 and 6, the horn coupling member 140 includes a base portion 142 that receives the first end 121 of the central pipe member 120 such that the interior surface of the base portion 142 abuts against the exterior surface 124 of the central pipe member 120 at the first end 121 such that the horn coupling member 140 may be fastened to the central pipe member 120. The horn coupling member 140 also includes a horn 141 having an enlarged diameter that is configured to engage and connect to a discharge port (not shown) in the rear of the water closet to form a tight fluid connection between the coupling assembly 100 and the water closet, and to place the internal passage 150 of the coupling assembly 100, and thereby the carrier system 10, in fluid communication with the water closet such that waste fluid released from the water closet when the water closet is flushed is conveyed into the internal passage 150 of the coupling assembly 100. The horn coupling member 140 includes an internal shoulder 143 and an external shoulder 144 that are formed on the interior and the exterior of the horn coupling member 140 between the horn 141 and the base portion 142. As shown in FIG. 6, the central pipe member 120 may be inserted in the base portion 142 such that the first end 121 of the central pipe member 120 is aligned with the internal shoulder 143 of the horn coupling member 140. In this manner, the internal passage 150 of the coupling assembly 100 may be placed in as close to direct fluid communication with the rear of the water closet as is possible. According to one embodiment, the coupling assembly 100 is configured such that horn coupling members 140 of various sizes and configurations may be utilized in the coupling assembly 100. In this manner, a customer, contractor, or installer may choose a horn coupling member 140 suitable for the water closet being installed when ordering the coupling assembly 100, or the coupling assembly 100 may be provided with a variety of horn coupling members 140 that are suitable for a number of different water closets, and the contractor or installer may then choose the most suitable one of the horn coupling members 140 provided during installation.

According to one embodiment of the invention, the entire coupling assembly 100 including the adapter member 110, the central pipe member 120, the cap member 130, and the horn coupling member 140 are made from PVC, and the adhesive utilized for fastening the adapter member 110 and the horn coupling member 140 to the central pipe member 120 is PVC cement. PVC cement may also be used to removably fasten the cap member 130 to the central pipe member 120. It is to be appreciated, however, that the coupling assembly may be formed from any plastic, metal, or ceramic material and fastened by any adhesive, welding, or chemical or mechanical fastener system known to be suitable to those having ordinary skill in the art.

With reference to FIGS. 1-6, a method of assembling a closet carrier system 10 for a water closet includes providing a faceplate 11; providing at least one vertical support 20; adjustably connecting the at least one vertical support 20 to the faceplate 11 for supporting the carrier 10 on a floor surface; and providing the coupling assembly 100. The method further includes fixedly connecting the adapter member 110 of the coupling assembly 100 to the second end 122 of the central pipe member 120 such that the hollow interior of the central pipe member 120 and the hollow interior of the adapter member 110 form at least a portion of the internal passage 150 of the coupling assembly 100; fixedly connecting the horn coupling member 140 to the first end 121 of the central pipe member 120; and adjustably connecting the adapter member 110 to the faceplate 11 to connect the coupling assembly 100 to the faceplate 11. The horn coupling member 140 of the coupling assembly 100 connects the carrier system 10 to a water closet to place the internal passage 150 of the coupling assembly 100 in fluid communication with the water closet. The adapter member 110 and the horn coupling member 140 may be fixedly connected to the central pipe member 120 by an adhesive, such as PVC cement.

The method may also include providing a cap member 130 of the coupling assembly 100; prior to fixedly connecting the horn coupling member 140 to the central pipe member 120, removably connecting the cap member 130 to the first end 121 of the central pipe member 120 to close the internal passage 150 of the coupling assembly 100; after adjustably connecting the adapter member 110 to the faceplate 11, conducting a pressure test on the carrier system 10; and removing the cap member 130 from the first end 121 of the central pipe member 120 after conducting the pressure test. Additionally, the method may further include measuring a distance between a position of the water closet and a desired position of the faceplate 11; and adjusting a length of the central pipe member 120 so that an overall length of the coupling assembly 100 corresponds to the measured distance. The adjustment to the length of the central pipe member may be performed by cutting away a portion of the central pipe member 120.

According to one aspect of the invention, the method may include providing a horn coupling member 140 specifically configured for a particular water closet in order to connect the coupling assembly 100 with the water closet. According to another aspect of the invention, the method may include providing a plurality of horn coupling members 140 suitable for connecting to a number of different water closets.

The method may also include providing a waste fitting 40; connecting the waste fitting 40 on a side of the faceplate 11 opposite from a side 12 of the faceplate 40 to which the coupling assembly 100 is connected such that the waste fitting 40 is in fluid communication with the coupling assembly 100 and, therefore, in fluid communication with the water closet via the coupling assembly.

While specific embodiments of the invention have been described in detail, it will be appreciated by those having ordinary skill in the art that various modifications and alternatives to those details could be developed in light of the overall teachings of the disclosure. The presently preferred embodiments described herein are meant to be illustrative only and not limiting as to the scope of the invention, which is to be given the full breadth of the appended claims and any and all equivalents thereof.

The invention claimed is:

1. A coupling assembly for a closet carrier system for a water closet, the coupling assembly comprising:
a central pipe member having a first end and a second end, and an interior surface defining a hollow interior;
an adapter member separate from the central pipe member and connected to the second end of the central pipe member, the adapter having an interior surface defining a hollow interior and the adapter member being configured to adjustably connect the coupling assembly to a faceplate of the closet carrier system; and
a horn coupling member configured to be connected to the first end of the central pipe member,
wherein at least the hollow interior of the central pipe member and the hollow interior of the adapter member form an internal passage of the coupling assembly, and wherein the horn coupling member is configured to be connected to a water closet to place the internal passage of the coupling assembly in fluid communication with the water closet.

2. The coupling assembly according to claim 1, further comprising:
a cap member configured to be removably connected to the central pipe member, wherein the cap member is configured to close the internal passage of the coupling assembly during a pressure test.

3. The coupling assembly according to claim 2, wherein the cap member is configured to be removably connected to the central pipe member by an adhesive.

4. The coupling assembly according to claim 1, wherein the adapter member comprises a widened portion that receives the second end of the central pipe member and a threaded portion with external threading configured to threadably engage the faceplate of the closet carrier system.

5. The coupling assembly according to claim 4, wherein the adapter member further comprises an internal flange formed in the interior surface of the adapter member between the threaded portion and the widened portion, and the internal flange is configured to abut against the second end of the central pipe member when the central pipe member is fully inserted into the widened portion of the adapter member.

6. The coupling assembly according to claim 4, wherein the adapter member further comprises an external flange formed in an exterior of the adapter member between the threaded portion and the widened portion, and the external flange is configured to abut against the faceplate of the closet carrier system when the adapter member is connected to the faceplate.

7. The coupling assembly according to claim 1, wherein the horn coupling member comprises a base portion configured to receive the first end of the central pipe member and a horn having an enlarged diameter and configured to engage and connect to the water closet.

8. The coupling assembly according to claim 1, wherein the adapter member is connected to the second end of the central pipe member by an adhesive.

9. The coupling assembly according to claim 1, wherein the horn coupling member is configured to be connected to the first end of the central pipe member by an adhesive.

10. A closet carrier system for a water closet, comprising:
a faceplate;
at least one vertical support adjustably connected to the faceplate for supporting the system on a floor surface; and
a coupling assembly connected to and extending from the faceplate, the coupling assembly comprising:
a central pipe member having a first end and a second end, and an interior surface defining a hollow interior;
an adapter member separate from the central pipe member and connected to the second end of the central pipe member, the adapter having an interior surface defining a hollow interior and the adapter member adjustably connecting the coupling assembly to the faceplate; and
a horn coupling member configured to be connected to the first end of the central pipe member,
wherein at least the hollow interior of the central pipe member and the hollow interior of the adapter member form an internal passage of the coupling assembly, and wherein the horn coupling member is configured to be connected to a water closet to place the internal passage of the coupling assembly in fluid communication with the water closet.

11. The closet carrier system according to claim 10, further comprising:
a cap member configured to be removably connected to the first end of the central pipe member, wherein the cap member is configured to close the internal passage of the coupling assembly during a pressure test of the closet carrier system.

12. The closet carrier system according to claim 10, wherein the adapter member comprises a widened portion that receives the second end of the central pipe member and a threaded portion with external threading configured to threadably engage the faceplate.

13. The closet carrier system according to claim 10, wherein the adapter member further comprises an internal flange formed in the interior surface of the adapter member between the threaded portion and the widened portion, and the internal flange is configured to abut against the second end of the central pipe member when the central pipe member is fully inserted into the widened portion of the adapter member.

14. The closet carrier system according to claim 10, wherein the adapter member further comprises an external flange formed in an exterior of the adapter member between the threaded portion and the widened portion, and the external flange is configured to abut against the faceplate when the adapter member is connected to the faceplate.

15. The closet carrier system according to claim 10, wherein the horn coupling member comprises a base portion configured to receive the first end of the central pipe member and a horn having an enlarged diameter and configured to engage and connect to the water closet.

16. A method of assembling a closet carrier system for a water closet, comprising:
providing a faceplate;
providing at least one vertical support;
adjustably connecting the at least one vertical support to the faceplate for supporting the carrier system on a floor surface;
providing a coupling assembly, comprising:
a central pipe member having a first end and a second end, and an interior surface defining a hollow interior;
an adapter member separate from the central pipe member, the adapter having an interior surface defining a hollow interior; and
a horn coupling member;
fixedly connecting the adapter member to the second end of the central pipe member such that the hollow interior of the central pipe member and the hollow interior of the adapter member form at least a portion of an internal passage of the coupling assembly;
fixedly connecting the horn coupling member to the first end of the central pipe member; and
adjustably connecting the adapter member to the faceplate to connect the coupling assembly to the faceplate,
wherein the horn coupling member is configured to be connected to a water closet to place the internal passage of the coupling assembly in fluid communication with the water closet.

17. The method according to claim 16, further comprising:
providing a cap member of the coupling assembly;
removably connecting the cap member to the first end of the central pipe member prior to fixedly connecting the horn coupling member to close the internal passage of the coupling assembly;
after adjustably connecting the adapter member to the faceplate, conducting a pressure test on the closet carrier system; and
removing the cap member from the first end of the central pipe member after conducting the pressure test.

18. The method according to claim 16, further comprising:
measuring a distance between a position of the water closet and a desired position of the faceplate; and
adjusting a length of the central pipe member so that an overall length of the coupling assembly corresponds to the measured distance.

19. The method according to claim 18, wherein the step of adjusting the length of the central pipe member comprises cutting away a portion of the central pipe member.

20. The method according to claim 16, wherein the adapter member and the horn coupling member are fixedly connected to the central pipe member by an adhesive.
